(19) United States
(12) Patent Application Publication
(10) Pub. No.: US 2006/0023843 A1
(43) Pub. Date: Feb. 2, 2006

(54) Cone-beam imaging for brachytherapy

(76) Inventor: Jochen Klaus Kusch, Concord, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/900,684

(22) Filed: Jul. 27, 2004

(51) Int. Cl. H05G 1/02

(52) U.S. Cl. 378/197

(57) ABSTRACT

A system includes delivery of one or more radiation sources to an internal patient portion within an operating theatre, and acquisition of three-dimensional X-ray data of the internal patient portion and the one or more radiation sources within the operating theatre. The system may also include identification of areas of the internal patient portion that may not receive sufficient radiation based on the three-dimensional X-ray data, and delivery of one or more additional radiation sources to the internal patient portion within the operating theatre based on the identified areas.

### BACKGROUND

1. Field

The embodiments described below relate generally to the delivery and verification of radiation sources within a patient.

2. Description

Brachytherapy involves the placement of radioactive sources within a patient. Radiation emitted by the radiation sources is intended to destroy diseased tissue within the patient. The radiation sources may comprise radioactive pellets known as “seeds”. Each radiation source typically emits radiation over a small area; therefore the radiation sources are usually placed within and/or near the diseased tissue. Brachytherapy has been used to treat prostate cancer, cervical cancer, endometrial cancer, breast cancer, coronary artery disease, and other ailments.

The radiation sources may remain permanently within the patient, or may be removed after a designated time. As an example of the first alternative, radiation sources are placed within an internal patient portion, each radiation source emits radiation within a radius of a few millimeters, and the radiation emitted by each radiation source decays to a negligible dose after several months. In the second alternative, radioactive sources are placed as described above, but may be removed after several minutes. Radiation sources used in the second alternative typically emit a significantly higher radiation dose than sources used in the first alternative.

The radioactive sources may be delivered to the appropriate internal patient portion within an operating theatre. In some cases, the patient is sedated and a hollow needle or other delivery instrument is delivered to the internal patient portion through the skin, an artery or an orifice. Ultrasound imaging may be used to guide the delivery instrument to the patient portion. One or more radiation sources are then delivered through the delivery instrument to the patient portion.

A two-dimensional X-ray image of the internal patient portion and the radiation sources may be acquired after the radiation sources are delivered. The X-ray image may be used to roughly verify the proper placement of the radiation sources. Ultrasound imaging is usually not suitable for this purpose because bleeding caused by the delivery of the radioactive sources results in unclear ultrasound images. Moreover, ultrasound imaging is optimized for soft tissue and does not provide satisfactory resolution of the radiation sources or surrounding bone structures. The radiation sources are then removed while the patient is in the operating theatre if the second treatment alternative described above is being employed.

If the radiation sources are to remain within the patient for an extended period (e.g. permanently), then computed tomography (CT) data of the internal patient portion and the radiation sources may be acquired many days after the above-described procedure. Many days are permitted to elapse so that inflammation of the internal patient portion may substantially subside.

The CT data is acquired by a CT scanner, which is a large piece of equipment including an X-ray source and a radiation receiver that are mounted to face one another on opposite sides of a ring. The patient is positioned within the ring so that the internal patient portion lies between the X-ray source and the radiation receiver. The X-ray source then emits X-ray radiation that passes through the internal patient portion and is received by the radiation receiver as the ring rotates around the patient. A three-dimensional image of the internal patient portion may be generated from the radiation received by the radiation receiver using known reconstruction techniques.

The CT data is used to determine areas of the internal patient portion, or “cold spots”, that may not receive sufficient radiation from the radiation sources. If any cold spots are identified, additional radiation sources may be delivered to the internal patient portion by again preparing an operating theatre, preparing and sedating the patient, and delivering the additional radiation sources to the internal patient portion with a delivery system.

More efficient verification and/or adjustment of brachytherapy treatment is desired.

### SUMMARY

To address at least the foregoing, some embodiments provide a system, method, apparatus, and means to deliver one or more radiation sources to an internal patient portion within an operating theatre, and acquire three-dimensional X-ray data of the internal patient portion and the one or more radiation sources within the operating theatre.

In some aspects, areas of the internal patient portion that may not receive sufficient radiation are then identified based on the three-dimensional X-ray data. Further aspects may include changing a position of one of the one or more radiation sources and/or delivery of one or more additional radiation sources to the internal patient portion within the operating theatre based on the identified areas.

According to additional aspects, a system is provided including a delivery system to deliver one or more radiation sources to an internal patient portion within an operating theatre, and an imaging system to acquire three-dimensional X-ray data of the internal patient portion and the one or more radiation sources within the operating theatre.

Further to the foregoing aspect, a computing system may be included to identify areas of the internal patient portion that may not receive sufficient radiation based on the three-dimensional X-ray data. The delivery system may be used to change a position of one of the one or more radiation sources and/or deliver one or more additional radiation sources to the internal patient portion within the operating theatre based on the identified areas.

The claimed invention is not limited to the disclosed embodiments, however, as those in the art can readily adapt the description herein to create other embodiments and applications.

### BRIEF DESCRIPTION OF THE DRAWINGS

The construction and usage of embodiments will become readily apparent from consideration of the following specification as illustrated in the accompanying drawings, in which like reference numerals designate like parts, and wherein:

FIG. 1 is a block diagram of elements within an operating theatre according to some embodiments;

FIG. 2 is a diagram illustrating acquisition of data of an internal patient portion within an operating theatre according to some embodiments;

FIG. 3 is a block diagram illustrating acquisition of data of an internal patient portion within an operating theatre according to some embodiments;

FIG. 4 comprises a flow diagram illustrating process steps according to some embodiments;

FIG. 5 comprises a two-dimensional representation of three-dimensional data according to some embodiments;

FIG. 6 comprises a two-dimensional representation of three-dimensional data and areas that may receive sufficient radiation according to some embodiments;

FIG. 7 comprises a two-dimensional representation of three-dimensional data and areas that may receive sufficient radiation according to some embodiments;

FIGS. 8A and 8B are diagrams illustrating acquisition of data of an internal patient portion within an operating theatre according to some embodiments; and

FIG. 9 is a diagram illustrating acquisition of data of an internal patient portion within an operating theatre according to some embodiments.

### DETAILED DESCRIPTION

The following description is provided to enable any person skilled in the art to make and use the claimed invention and sets forth the best mode contemplated by the inventor for carrying out the claimed invention. Various modifications, however, will remain readily apparent to those in the art.

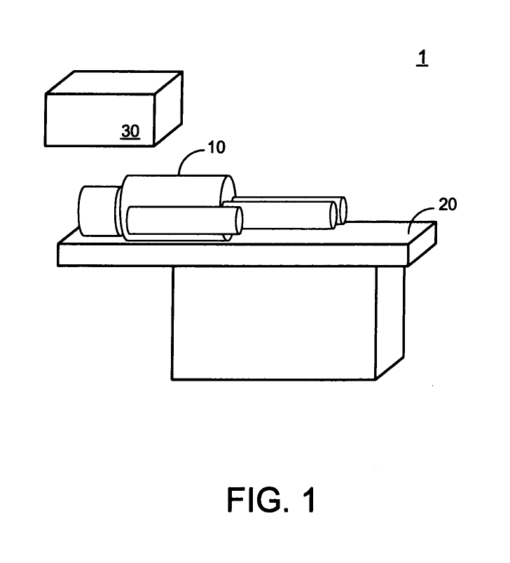

FIG. 1 illustrates operating theatre 1 according to some embodiments. Operating theatre 1 is an area equipped with systems for the delivery of radiation sources to an internal patient portion. Such systems may include one or more of systems for delivering any prescribed anaesthetic to a patient, for monitoring physiological indicators of the patient, for maintaining a substantially sterile environment, for delivering radiation sources to an internal patient portion, or for performing any other desired task. Operating theatre 1 may comprise an operating room located in a hospital, a clinic, or a doctor's office, but embodiments are not limited thereto.

Operating theatre 1 of FIG. 1 comprises patient 10, table 20 and delivery system 30. Patient 10 is supported by table 20, which may be adjustable to assist in positioning an internal portion of patient 10 with respect to delivery system 30. Delivery system 30 may comprise any one or more mechanical, hardware and/or software devices for delivering one or more radiation sources to the internal patient portion.

In the present example, multiple radiation sources are to be delivered to a portion inside the neck of patient 10. The radiation sources may comprise any currently- or hereafter-known radiation sources, including but not limited to implants based on Iodine-125 and Palladium-103. The radiation sources may have any physical dimensions, and may comprise several different elements in any arrangement. Configurations of table 20, delivery system 30, and/or the radiation sources may differ depending on the type of brachytherapy to be performed on patient 10.

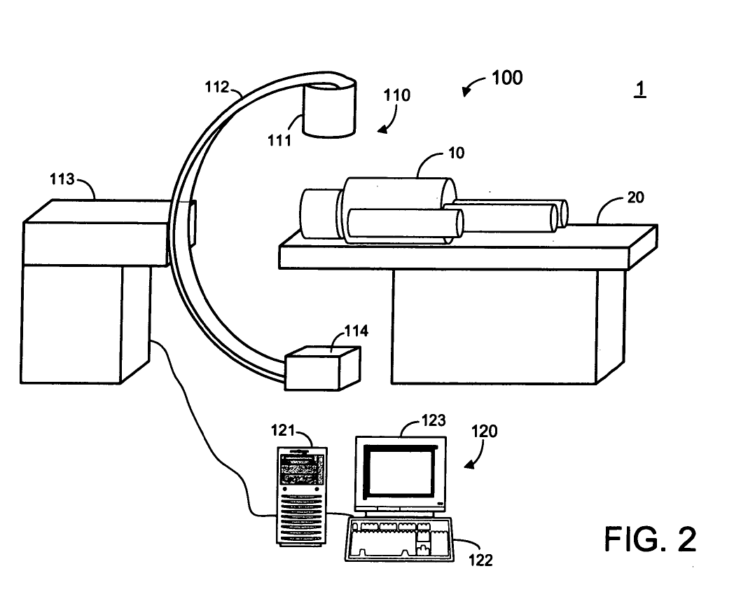

FIG. 2 illustrates imaging system 100 within operating theatre 1. According to some embodiments, imaging system 100 is used to acquire three-dimensional X-ray data of an internal patient portion and one or more delivered radiation sources. In further aspects, cold spots of the internal patient portion are identified based on the three-dimensional X-ray data and, based on the identified cold spots, additional radiation sources are delivered to the internal patient portion within operating theatre 1. Delivery system 30 may or may not be located in operating theatre 1 at the same time as imaging system 100, but is omitted from FIG. 2 for the sake of clarity.

Imaging system 100 includes kilovoltage imaging system 110 and operator station 120. Kilovoltage imaging system 110 comprises X-ray tube 111, C-arm 112, base 113 and imaging device 114. X-ray tube 111 may comprise any suitable device to emit imaging radiation, including but not limited to a Diabolo® X-ray tube. In some embodiments, X-ray tube 111 emits kilovoltage radiation having energies ranging from 50 to 150 keV. Imaging device 114 may comprise a flat-panel imaging device using a scintillator layer and solid-state amorphous silicon photodiodes deployed in a two-dimensional array. The RID1640, offered by Perkin-Elmer®, Inc. of Fremont, Calif., is one suitable device.

Imaging device 114 may comprise other types of imaging devices. For example, X-ray radiation may also be converted to and stored as electrical charge without use of a scintillator layer. In such imaging devices, X-rays are absorbed directly by an array of amorphous selenium photoconductors. The photoconductors convert the X-rays directly to stored electrical charge that comprises an acquired image of a radiation field. Imaging device 114 may also comprise a CCD or tube-based camera. Such an imaging device may include a light-proof housing within which are disposed a scintillator, a mirror, and a camera.

X-ray tube 111 and imaging device 114 may be coupled to C-arm 112 so as to face one another irrespective of any movement of C-arm 112 with respect to base 113. In this regard, C-arm 112 is slidably mounted on base 113 and can therefore be moved in order to change the position of X-ray tube 111 with respect to table 20. In some embodiments, base 113 also includes a high-voltage generator for supplying power used by X-ray tube 111 to generate kilovoltage radiation.

Many C-arm/base configurations may be used in conjunction with some embodiments, including portable configurations, configurations in which base 113 is rotatably mounted to a ceiling of operating theatre 1, configurations in which one C-arm is slidably mounted on another C-arm, and configurations incorporating multiple independent C-arms. Embodiments of imaging system 110 may comprise one of the SIREMOBIL®, MULTISTAR®, BICOR® and POLYSTAR® systems produced by Siemens Corporation® or other systems designed to perform tomography and/or angiography.

Operator station 120 includes processor 121 in communication with an input device such as keyboard 122 and operator display 123. An operator may operate operator station 120 to instruct imaging system 110 to acquire projection images of an internal patient portion and one or more radiation sources delivered to the internal patient portion. Operator station 120 may also or alternatively reconstruct three-dimensional data from projection images acquired by imaging system 110.

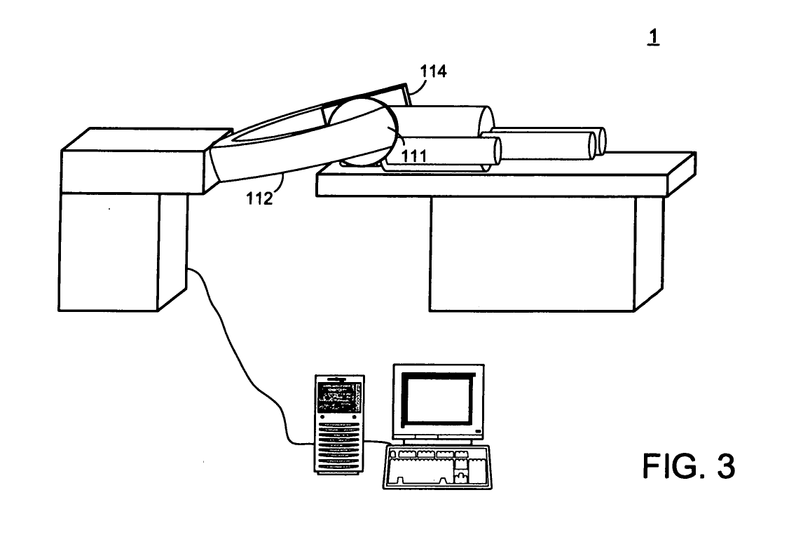

In one example of the foregoing operation, patient 10 is positioned on table 20 while X-ray tube 111 and imaging device 114 are rotated around an internal patient portion of interest. At various points during the rotation, X-ray tube 111 emits imaging radiation and imaging device 114 acquires a projection image based on the imaging radiation. FIG. 3 illustrates the positions of X-ray tube 111, C-arm 112 and imaging device 114 at one point during this rotation. Processor 121 may execute program code to create three-dimensional X-ray data of the internal patient portion based on the acquired projection images. The executed code may reflect currently- or hereafter-known cone beam reconstruction techniques or any other suitable technique.

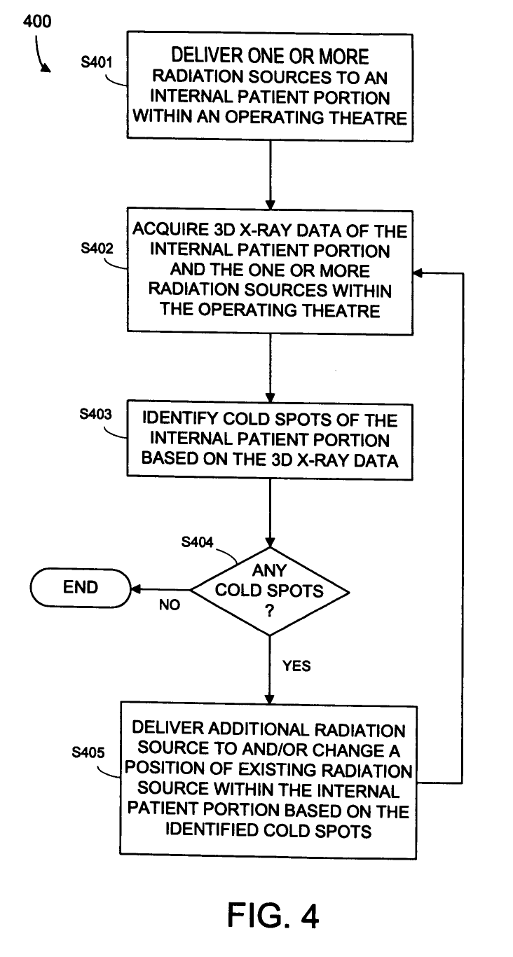

FIG. 4 is a flow diagram of process steps 400 according to some embodiments. Process steps 400 may be embodied, in whole or in part, by hardware of and/or software executed by elements including but not limited to those of delivery system 30, and imaging system 100. Software embodying one or more of process steps 400 may be stored by any medium, including a fixed disk, a floppy disk, a CD-ROM, a DVD-ROM, a Zip™ disk, a magnetic tape, or a signal. Some or all of such software may also be stored in one or more devices.

Initially, at step S401, one or more radiation sources are delivered to an internal patient portion within an operating theatre. Delivery of the radiation sources may proceed according to a plan established by a radiation oncologist. As described above, delivery system 30 may be operated in some embodiments of step S401 to deliver brachytherapy seeds in any currently- or hereafter-known manner to an internal portion of patient 10.

Three-dimensional X-ray data of the internal patient portion and the one or more radiation sources is acquired within the operating theatre at step S402. Step S402 may be performed soon after the radiation sources are delivered so that the internal patient portion does not have time to swell substantially. According to some embodiments, imaging system 110 is moved from another room or from another area of operating theatre 1 into place around patient 10 prior to step S402.

Imaging system 110 may acquire projection images of the internal patient portion from various projection angles at step S402. For example, one projection image may be acquired while imaging system 110 is at the projection angle illustrated in FIG. 2, and another projection image may be acquired while imaging system 110 is at the projection angle illustrated in FIG. 3. As shown in both FIGS., the internal patient portion of interest remains between X-ray tube 111 and imaging device 114 at each projection angle. Processor 121 may then generate the three-dimensional X-ray data based on the acquired projection images using cone beam reconstruction techniques or any other suitable technique.

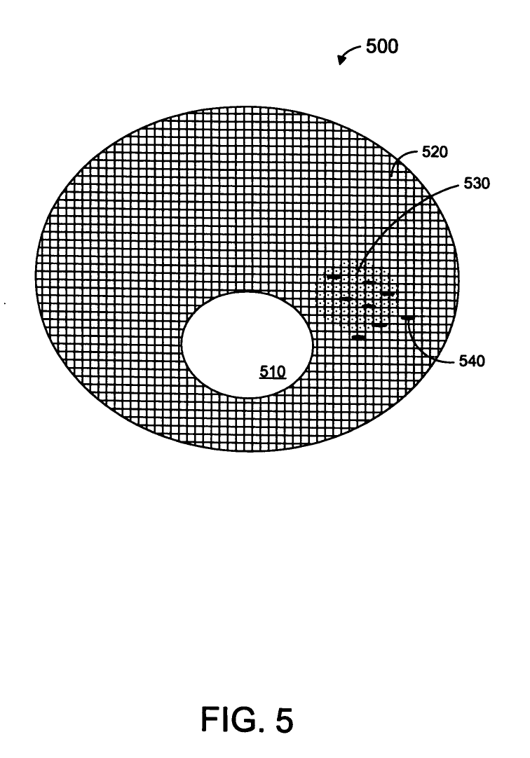

FIG. 5 comprises a two-dimensional representation of three-dimensional X-ray data acquired at step S402 according to some embodiments. Image 500 illustrates a two-dimensional “slice” of an internal portion of patient 10 taken perpendicular to the spine of patient 10. Image 500 shows spine 510, other tissue 520, tumor 530 and radiation sources 540.

Cold spots of the internal patient portion are identified at step S403 based on the three-dimensional X-ray data. A cold spot may comprise a volume of the internal patient portion that may not receive sufficient radiation from the radiation sources. For example, the locations of the radiation sources and the tissues surrounding the radiation sources may be determined based on the three-dimensional X-ray data. Next, a radiation dose distribution within the internal patient portion is determined based on the locations of the radiation sources, the known dose distribution patterns of the radiation sources, and the tissues surrounding the radiation sources.

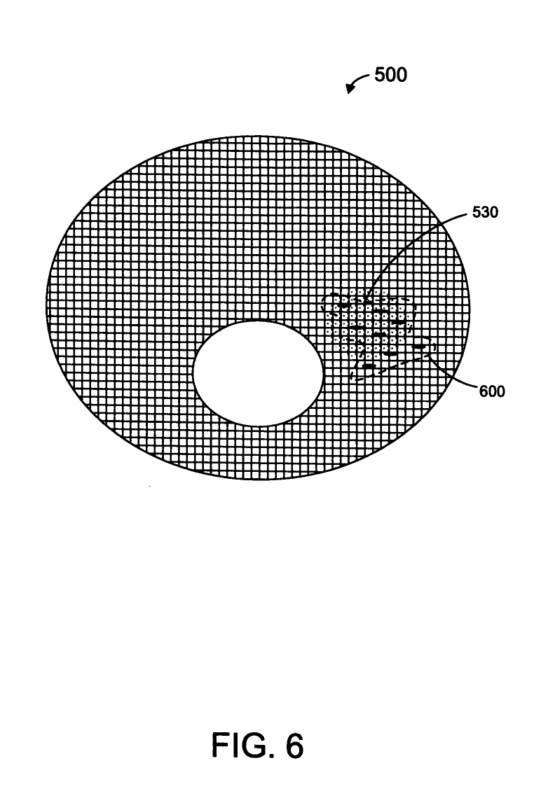

FIG. 6 is identical to FIG. 5 except for dashed line 600, which represents a radiation dose distribution that may be determined as described above in step S402. In the illustrated example, dashed line 600 circumscribes areas that receive a radiation dose that is greater than a minimum dose prescribed by a radiation oncologist. Other methods for indicating dose distribution may be used in conjunction with some embodiments.

The radiation dose distribution is then analyzed during step S403 to identify any volumes of the internal patient portion that do not receive a particular dose of radiation that was prescribed by a radiation oncologist. The volumes may be identified automatically and/or by visual inspection of an image such as image 500 of FIG. 6. In the present example, it will be assumed that areas of tumor 530 that are not circumscribed by dashed line 600 are identified as cold spots in step S403.

Although two-dimensional representations are shown in FIG. 5 and FIG. 6, it should be noted that three-dimensional X-ray data is acquired and used to identify cold spots in steps S402 and S403. Usage of three-dimensional X-ray data may provide more accurate dose distribution patterns and therefore more accurate identification of cold spots than conventional systems.

Next, at step S404, it is determined whether any cold spots have been identified. If not, process steps 400 terminate. According to some embodiments, the determination of step S404 is negative if the total volume of any identified cold spots is less than a predefined threshold. If cold spots have been identified, flow proceeds to step S405.

At step S405, one or more additional radiation sources is delivered to the internal patient portion based on the identified cold spots. Also (or alternatively), a position of a previously-delivered radiation source is changed based on the identified cold spots.

Step S405 occurs while patient 10 is within operating theatre 1 according to some embodiments. In some embodiments, process steps 400 are executed while patient 10 remains in operating theatre 1. Such embodiments may provide more efficient delivery of brachytherapy than conventional systems. Patient 10 may remain under various degrees of sedation throughout process steps 400.

Flow returns to step S402 from step S405 and continues as described above to acquire three-dimensional X-ray data of the internal patient portion and to identify cold spots based on the new arrangement of radiation sources within the internal patient portion. According to some embodiments, flow terminates after S405 without returning to step S402.

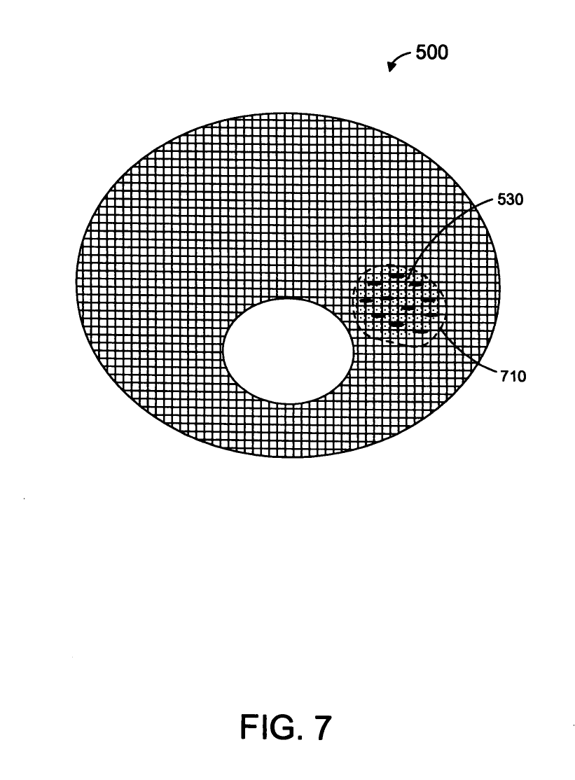

Image 700 of FIG. 7 comprises a two-dimensional representation of three-dimensional X-ray data acquired during a second iteration of step S402 according to some embodiments. Image 700 includes dashed line 710, which represents a radiation dose distribution determined during the second iteration of step S402. Continuing with the present example, no cold spots are then identified in step S403 because dashed line 710 completely circumscribes tumor 530. Accordingly, flow proceeds to step S404 and then terminates.

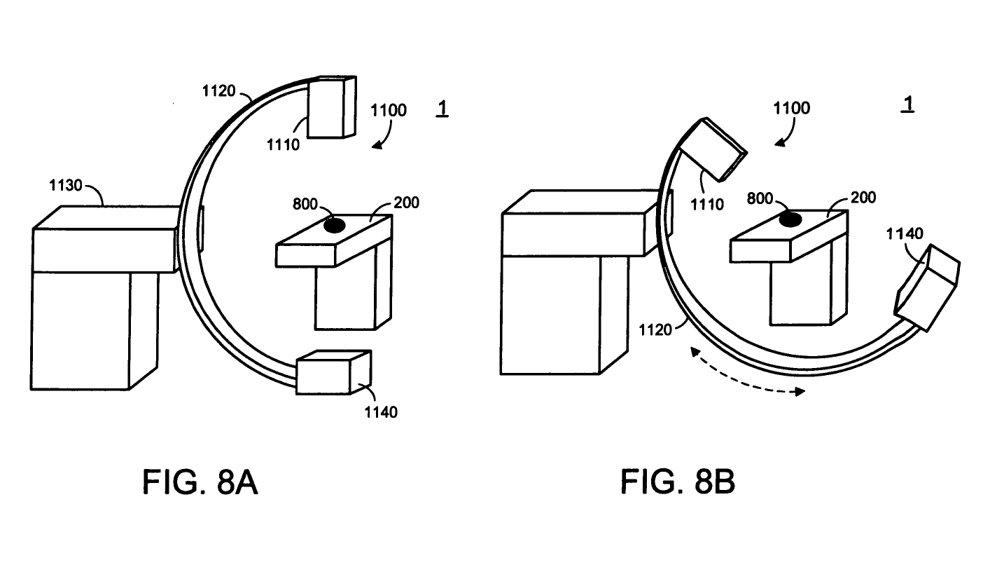

FIGS. 8A and 8B illustrate imaging system 1100 within operating theatre 1 according to some embodiments. Imaging system 1100 may be used to acquire three-dimensional X-ray data of an internal patient portion according to some embodiments of step S402. Imaging system 1100 may comprise any configuration described above with respect to imaging system 110.

FIG. 8A shows X-ray tube 1110, C-arm 1120, base 1130 and imaging device 1140 configured to acquire a two-dimensional image of internal patient portion 800 of a patient (not shown) laying on table 200. X-ray tube 1110, C-arm 1120, base 1130 and imaging device 1140 may comprise any suitable currently- or hereafter-known implementations of such devices, including those mentioned above with respect to elements 111 through 114.

FIG. 8B shows elements 1110 through 1140 configured to acquire a two-dimensional image of internal patient portion 800 at a projection angle different from the projection angle illustrated in FIG. 8A. More specifically, C-arm 1120 has moved orbitally around internal patient portion 800 such that portion 800 remains between tube 1110 and imaging device 1140. According to some embodiments, C-arm 1120 may move in either direction indicated by the dashed line of FIG. 8B to acquire projection images of portion 800 at various projection angles. While FIG. 8B illustrates a “counterclockwise” movement from the position shown in FIG. 8A, C-arm 1120 may also move in a “clockwise” direction from the position shown in FIG. 8A.

The acquired projection images may be used to generate three-dimensional X-ray data. According to some embodiments, imaging system 1100 may acquire three-dimensional X-ray data using rotational movement as demonstrated in FIGS. 2 and 3 and/or orbital movement as illustrated in FIGS. 8A and 8B.

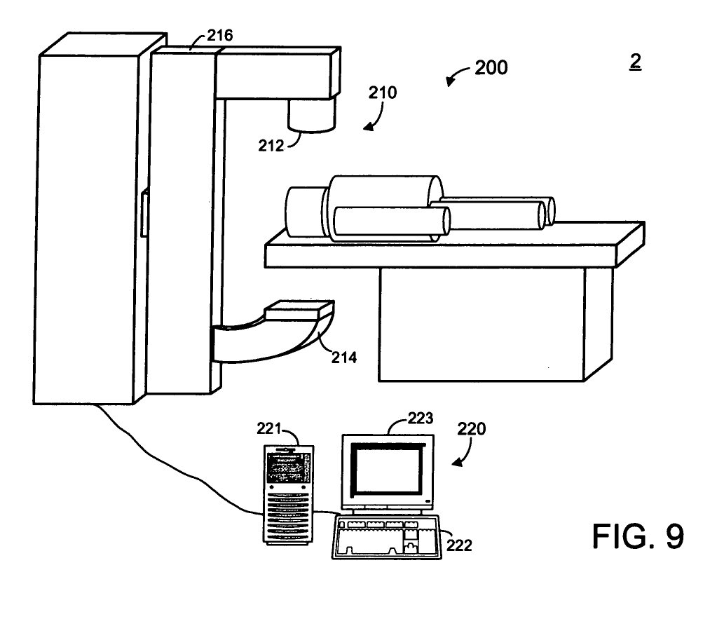

FIG. 9 illustrates imaging system 200 within operating theatre 2 according to some embodiments. System 200 includes linear accelerator 210, and operator station 220. Linear accelerator 210 may be used to deliver treatment radiation as well as radiation for acquiring three-dimensional X-ray data of an internal patient portion according to some embodiments.

System 200 may be used to perform some embodiments of steps S402, S403 and S404 of process steps 400. In this regard, a radiation source delivery system may be operable within operating theatre 2 to perform steps S401 and S405. The radiation source delivery system and linear accelerator 210 need not be simultaneously located within operating theatre 2 according to some embodiments.

Linear accelerator 210 comprises treatment head 212, imaging device 214, and gantry 216. Examples of linear accelerators that may be suitable in some embodiments include the PRIMUS® and ONCOR® systems offered by Siemens Corporation®. Imaging device 214 may comprise any suitable device, including those described above with respect to imaging device 114.

Gantry 216 may be rotated to dispose treatment head 212 and imaging device 214 at different rotational positions with respect to an internal portion of patient 10 disposed therebetween. Gantry 216 may be rotated continuously while imaging radiation is emitted from treatment head 212 to acquire projection images of the internal patient portion. Gantry 216 may be fixed at a particular rotational position when treatment radiation is to be emitted from treatment head 212.

Operator station 220 includes processor 221 in communication with an input device such as keyboard 222 and operator display 223. An operator may operate operator station 220 to instruct imaging system 210 to acquire projection images of an internal patient portion and one or more radiation sources delivered to the internal patient portion. Operator station 220 may also or alternatively reconstruct three-dimensional X-ray data from projection images acquired by imaging system 210.

Those in the art will appreciate that various adaptations and modifications of the above-described embodiments can be configured without departing from the scope and spirit of the claims. Therefore, it is to be understood that the claims may be practiced other than as specifically described herein.

What is claimed is:

1. A method comprising:
delivering one or more radiation sources to an internal patient portion within an operating theatre; and
acquiring three-dimensional X-ray data of the internal patient portion and the one or more radiation sources within the operating theatre.

2. A method according to claim 1, further comprising:
identifying areas of the internal patient portion that may not receive sufficient radiation based on the three-dimensional X-ray data.

3. A method according to claim 2, further comprising:
delivering one or more additional radiation sources to the internal patient portion within the operating theatre based on the identified areas.

4. A method according to claim 3, further comprising:
changing a position of one of the one or more radiation sources within the operating theatre based on the identified areas.

5. A method according to claim 3, further comprising:
after delivering the one or more additional radiation sources, acquiring second three-dimensional X-ray data of the internal patient portion, the one or more radiation sources, and the one or more additional radiation sources within the operating theatre.

6. A method according to claim 5, further comprising:
identifying areas of the internal patient portion that may not receive sufficient radiation based on the second three-dimensional X-ray data.

7. A method according to claim 2, further comprising:
changing a position of one of the one or more radiation sources within the operating theatre based on the identified areas.

8. A method according to claim 7, further comprising:
after changing the position of the radiation source, acquiring second three-dimensional X-ray data of the internal patient portion and the one or more radiation sources within the operating theatre.

9. A method according to claim 8, further comprising:
identifying areas of the internal patient portion that may not receive sufficient radiation based on the second three-dimensional X-ray data.

10. A method according to claim 1, wherein the three-dimensional X-ray data of the internal patient portion and the one or more radiation sources is acquired by a mobile radiation imaging system.

11. A method according to claim 1, wherein acquiring the three-dimensional X-ray data comprises:
acquiring projection images of the internal patient portion; and
generating the three-dimensional X-ray data based on the projection images.

12. A method according to claim 11, wherein acquiring the projection images comprises:
acquiring the plurality of images at a first projection angle with respect to the body.

13. A method according to claim 11, wherein the projection images are acquired by a C-arm imaging system.

14. A method according to claim 13, wherein the projection images are acquired by a mobile C-arm imaging system.

15. A method according to claim 11, wherein the projection images are acquired using a linear accelerator.

16. A system comprising:
a delivery system to deliver one or more radiation sources to an internal patient portion within an operating theatre; and
an imaging system to acquire three-dimensional X-ray data of the internal patient portion and the one or more radiation sources within the operating theatre.

17. A system according to claim 16, further comprising:
a computing system to identify areas of the internal patient portion that may not receive sufficient radiation based on the three-dimensional X-ray data.

18. A system according to claim 17, the delivery system to deliver one or more additional radiation sources to the internal patient portion within the operating theatre based on the identified areas.

19. A system according to claim 18, the delivery system to change a position of one of the one or more radiation sources within the operating theatre based on the identified areas.

20. A system according to claim 18, the imaging system to acquire second three-dimensional X-ray data of the internal patient portion, the one or more radiation sources, and the one or more additional radiation sources within the operating theatre after the one or more additional radiation sources are delivered.

21. A system according to claim 20, the computing system to identify areas of the internal patient portion that may not receive sufficient radiation based on the second three-dimensional X-ray data.

22. A system according to claim 17, the delivery system to change a position of one of the one or more radiation sources within the operating theatre based on the identified areas.

23. A system according to claim 22, the imaging system to acquire second three-dimensional data of the internal patient portion and the one or more radiation sources within the operating theatre after the position of the radiation source is changed.

24. A system according to claim 23, the computing system to identify areas of the internal patient portion that may not receive sufficient radiation based on the second three-dimensional X-ray data.

25. A system according to claim 16, wherein the imaging system comprises:
a mobile radiation imaging system.

26. A system according to claim 16, wherein the imaging system is to acquire the three-dimensional X-ray data by acquiring projection images of the internal patient portion and by generating the three-dimensional X-ray data based on the projection images.

27. A system according to claim 26, wherein the imaging system is to acquire the projection images by acquiring the plurality of images at a first projection angle with respect to the body.

28. A system according to claim 26, wherein the imaging system comprises:
a C-arm imaging system.

29. A system according to claim 28, wherein the imaging system comprises:
a mobile C-arm imaging system.

30. A system according to claim 26, wherein the imaging system comprises:
a linear accelerator.
